(19) United States
(12) Patent Application Publication
(10) Pub. No.: US 2008/0147236 A1
(43) Pub. Date: Jun. 19, 2008

(54) Method and Apparatus for the Assembly and Welding of Automotive Door Panels

(75) Inventors: Claudio Insero, Latina (IT); Donato Lapadulla, Rionero in Vulture (Potenza) (IT); Claudio Pagano, Salerno (IT); Pasqualino Palumbo, Caserta (IT); Alastair Ross Tweedie, Ospitaletto (BS) (IT)

Correspondence Address: MERCHANT & GOULD PC, P.O. BOX 2903, MINNEAPOLIS, MN, 55402-0903, US

(73) Assignee: JOHNSON CONTROLLS AUTOMOTIVE S.R.L., Grugliasco (IT)

(21) Appl. No.: 11/910,519

(22) PCT Filed: Apr. 11, 2006
(86) PCT No.: PCT/IB06/51108

§ 371 Date: Oct. 2, 2007

(30) Foreign Application Priority Data
Apr. 14, 2005 (IT) TO2005A000247

(51) Int. Cl. G06F 19/00

(52) U.S. Cl. 700/245; 901/42

(57) ABSTRACT

A method for assembling and welding vehicle door panels is disclosed. At an initial assembly station (20) components (10, 10′) of the panels are assembled and arranged on carriages (14, 15) for carrying the panels, which are profiled in a way adaptable to the shape of the panels. The carriages with the components of the panels are automatedly transported to a welding station (20′). At such station a welding head (35), which is movable with a plurality of degrees of freedom, is automatedly positioned and orientated, and if necessary, the configuration of the welding head is automatedly changed. The carriages with the assembled and welded panels are automatedly transported to a removal station (20″). At such station, the assembled and welded panels are removed, and the unloaded plates or carriages are automatedly returned from the removal station to the initial station. Those of the operations which are automatedly performed are coordinated in adaptable and programmable fashion according to a processing sequence which depends from the design specifications of the panels.

The present invention refers to the systems for the assembly and welding of vehicle door panels.

In the automotive industry, door panels are fitted to the door frame for aesthetic, structural and safety reasons. The panels also act as a support for door handles, arm rests and pockets for objects. Their impact on the car interior design is important. Increasingly the panels are being designed in complex shapes comprising multiple components made of plastic or vegetable fibre materials which during the assembly process are welded together using ultrasonic or vibration generation methods.

Due to the shape of the panels and the necessity to ensure structural integrity the welding is a critical part of the assembly process. At present the prime components of the panels are assembled by hand into dedicated welding work stations equipped with multiple individual fixed axis welding sonotrodes with dedicated tips for the specific weld to be performed, mounted in groups, each work station dedicated to a single specific door panel design (for example, left, right, front, back, five door, three door, etc.). The only movement of the welding tips is that necessary to perform the specific weld to which each tip is assigned, according to a fixed sequence. The grouping of the sonotrodes makes it difficult if not impossible to optimise the individual welds from both qualitative and throughput points of view. Holding the panel components stationary and in position during welding often requires complex mechanisms. On the other hand, an accidental movement of the parts often results in poor welds and scraps.

The welding work stations are dedicated to the specific panel design for the entire life of the automobile model and for the production of the ensuing spare parts (for a total period approximately greater than 15 years). During such period the work stations are not usable for any new automobile models or major design changes of the present models without reinvestments equal to an important fraction of the cost of the original equipment and production difficulties and scraps during such process of conversion. Final finishing of the panels is carried out at separate assembly work stations with assembling workers, which involves further risks of defects due to excessive handling of the panels.

The costs involved in the conventional processes are therefore rather high, particularly at change of automobile model and increases in production volumes, while the restricted movement and group positioning of the welding heads place creates restrictions on the design of the panel, both structurally and aesthetically, factors which may have repercussions on the design and saleability of the automobile.

It is the object of the present invention to reduce the impact of the above mentioned costs and design restrictions in a process for assembling automotive door panels.

According to the invention, such object is achieved by a method for assembling and welding vehicle door panels having the features defined in claim 1, and by an apparatus assembling and welding vehicle door panels having the features defined in claim 3.

In fact, in a method and apparatus according to the invention the panel components are completely assembled and welded in a flexible modular manufacturing process which permits the welding of complex shapes in complex positions and which can be adapted in a relatively simple and economic way to design and/or production volume changes.

Preferred embodiments of the invention are defined in the dependent claims.

Further features and advantages of the invention will become apparent from the following detailed description, carried out in a purely explanatory not limitative manner, with reference to the appended drawings, in which:

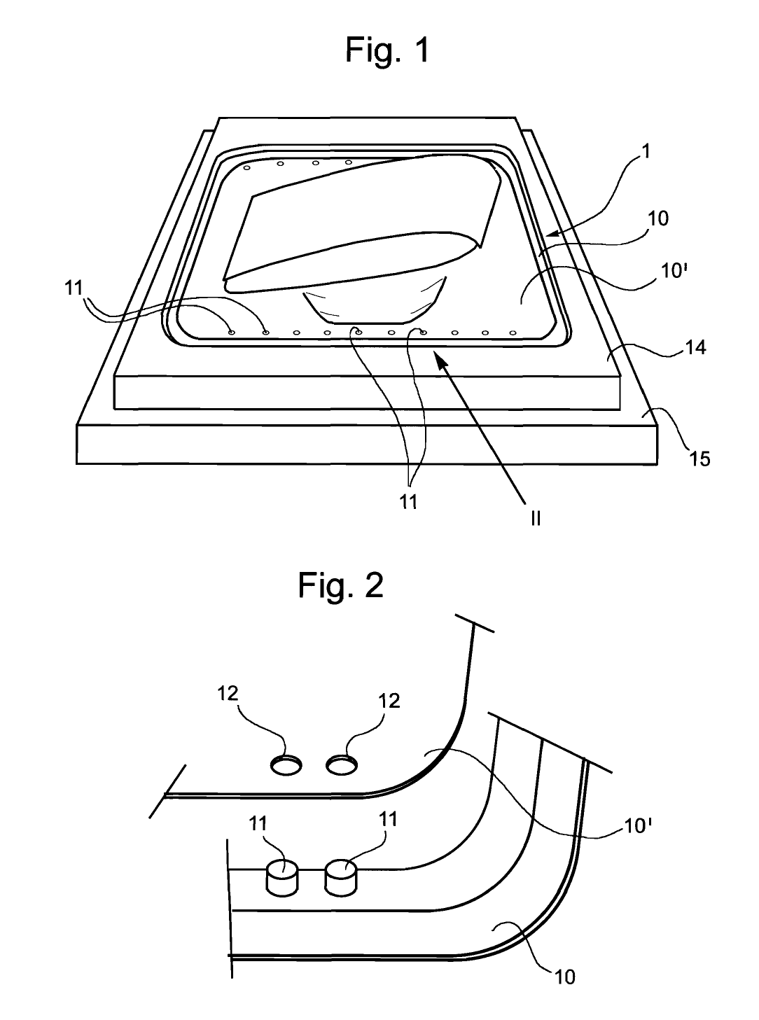

FIG. 1 is a view from the top of door panel components in their assembly condition, arranged in a carriage or platform, before welding;

FIG. 2 is an exploded view of a detail of the components shown in FIG. 1, indicated by arrow II of such figure;

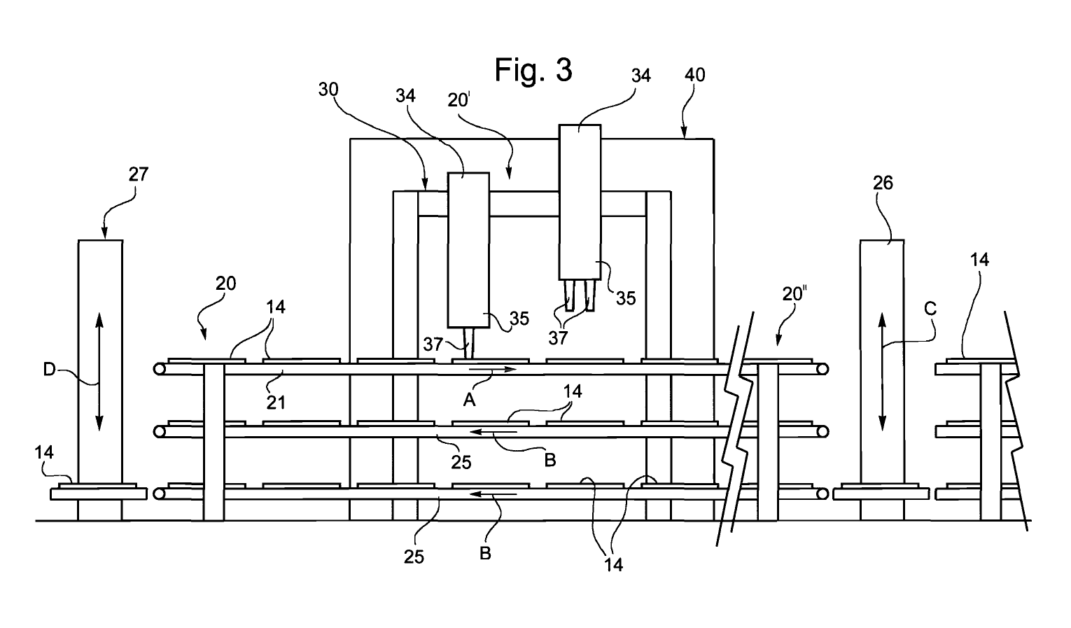

FIG. 3 is a schematic, side elevation view of an apparatus for the assembly and welding of door panels according to the invention;

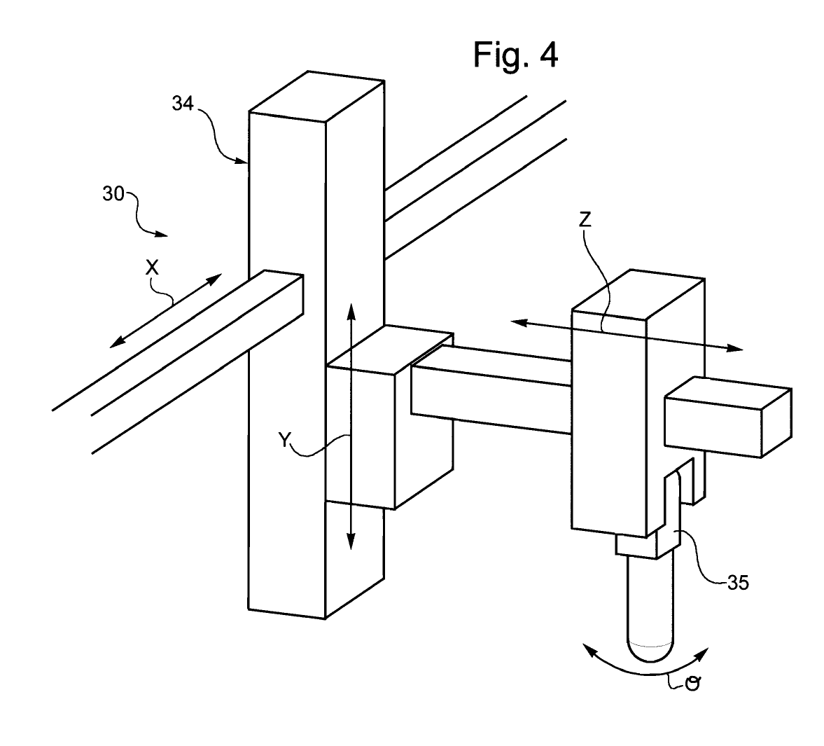

FIG. 4 is a schematic, perspective view of a welding machine of the apparatus of FIG. 3;

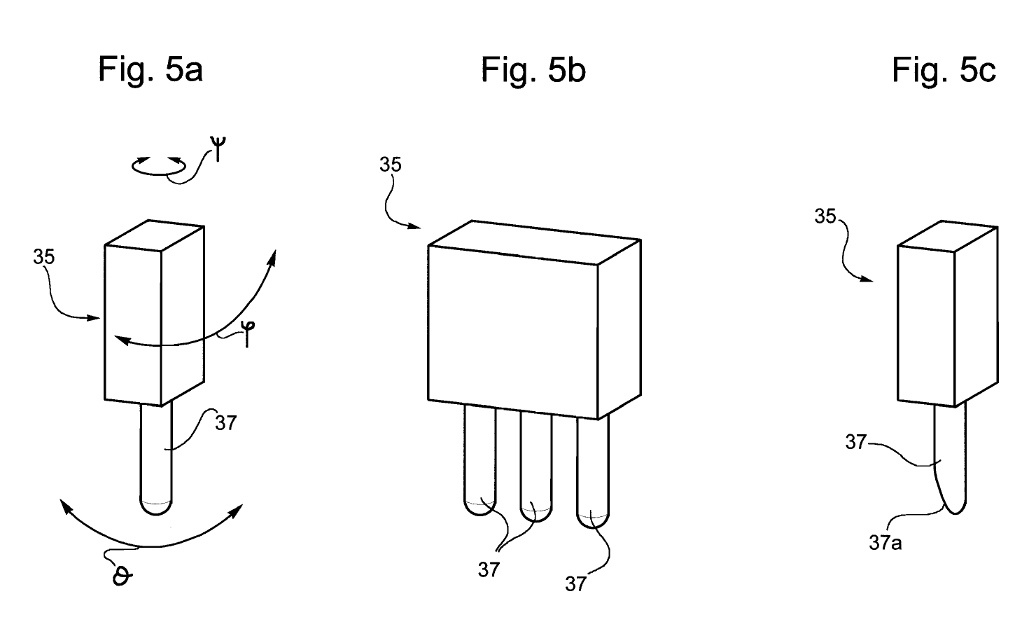

FIG. 5 are schematic, perspective views of welding heads for the machine of FIG. 4;

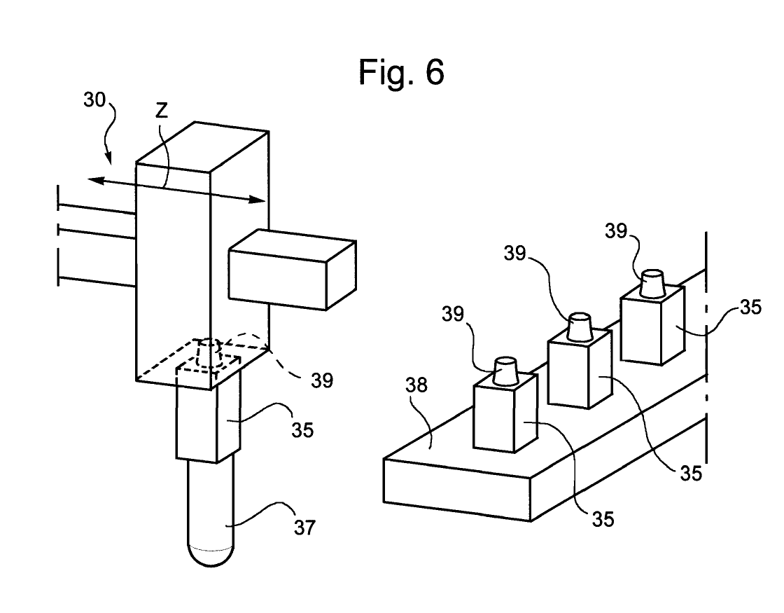

FIG. 6 is a schematic, perspective view of a part of the machine of FIG. 4 provided with a fitting for allowing the welding heads to be automatedly changed during the process of welding the panels;

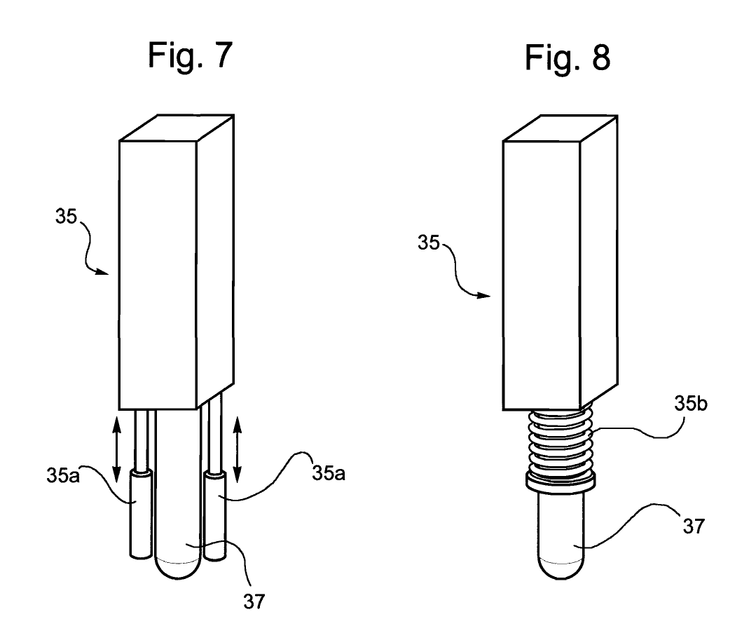

FIG. 7 is a schematic, perspective view of a welding head provided with adjustable height and position piston for securing in position the panel components during the welding; and

FIG. 8 is a schematic, perspective view of a welding head provided with a constant tension spring to ensure a sufficient pressure of the welding tool on the panel components.

With reference to the drawings, a door panel to be assembled by means of the method and apparatus of the invention is designated by 1 in FIG. 1. Such panels are normally of unique design for each automobile model, and are further divided between panels for front and back doors, and panels for right and left doors. Each panel 1 comprises a plurality of components 10, 10′ (for simplicity, only two of which are shown in FIGS. 1 and 2), which generally consist of a shell or a subassembly of regular or irregular form, made of plastic and/or fiber material. In order to allow the assembly of the parts, one or more of the components 10 are provided with welding locations in the form of sticks 11 integrally formed with the respective component 10. Another component, designated by 10′ and destined to be assembled with the first member 10, has corresponding holes 12. In this way the component 10 and the component 10′ form, respectively, the male part and the female part in a particular joint within the plurality of components which form the panel 1.

Before the welding, the components 10, 10′ are assembled in a carrier pallet or holder 14 which, in order to avoid scratching the components 10, 10′ is precision machined from a plastic material. The low cost carrier pallet 14 constitutes the only part of the present invention which is specifically dedicated to a specific panel design. There is a carrier pallet for each panel design and the number of pallets 14 required for an assembly line (shown in FIG. 2) is a function of the throughput volume required from the assembly line. The carrier pallet 14 is connected via bolts or other types of releasable connections to a carrier plate 15 which is of a standard design for all the carrier pallets 14, independently from the structure of the pallet 14 supported by it. The plate 15 and the pallet 14 together form a carriage or platform for transporting the assembled panel in the apparatus illustrated in FIG. 2.

As illustrated in FIG. 3, an assembly and welding apparatus or line according to the invention comprises a plurality of work stations or modules 20, 20′, 20″ disposed in sequence, through which the carrier pallets 14 pass from one assembly or welding operation to another along a conveyor line 21.

The pallets 14 are disposed in any order or sequence (for example, a left door panel for a three door car first, then a right door panel for a five door car, and so on) for each model of motor vehicle to be produced. At a station 20 the components 10 are loaded into the pallets 14 and assembled as previously described with reference to FIGS. 1 and 2. This assembly may be manual or automated. The pallets 14 then move along the conveyor line 21, in the direction of flow of the line as indicated by arrow A, through further modular assembly stations (not shown) which may be added to the line for specific assembly operations that may be manual or automated.

At least one welding station 20′ is arranged along the conveyor line 21, in which the panel 1 is ultrasonically welded in the predetermined welding locations, by riveting the sticks 11 of component 10 on component 10′. Such station 20′ will be described in greater detail in the following.

At the end of the line 21, after removal of the completed and welded door panel at the station 20″, the pallets 14 return to the start of the assembly line for reuse (according to the direction of arrows B). In order to allow the return of pallets 14 a multilayer conveyor system is arranged, which is provided with return lines 25 and is positioned under or over the assembly line 21, and a lift system 26, which allows the transfer of pallets 14 from the conveyor line 21 to the return lines 25 (according to the direction of arrow C). In order to repeat the process of the assembly line 21 the carrier pallets 15 are again brought up to the assembly line 21 via a second lift system 27 which transfers such pallets to the component loading station 20 (according to the direction of arrow D). The return lines 25 and lift systems 26 and 27 are controlled so as to arrange the pallets 14 at the station 20 in a predetermined sequence, thus generating a predetermined panel production sequence (for example, the right front door panel first, then the left front door panel, then the right back door panel, and finally the left back door panel). Such sequence for arranging the pallets 14 may alternatively be generated in a random way.

With reference to FIGS. 3 and 4, the welding station 20′ comprises at least one robotic, modular welding machine 30. Such machine comprises one or more three axis robot 34 (as indicated by the arrows x, y, z), fitted with a welding head 35. As indicated in FIG. 5a, at least one of the welding heads 35 is rotatable about at least one rotation axis, and preferably is multi axis, that is rotatable about more rotation axis, for example in the angular directions of the arrows φ, ψ, θ. As illustrated in FIG. 5b, at least one of the welding heads 35 may carry a plurality of sonotrodes 37 for ultrasonic welding. As illustrated in FIG. 5c, the tips 37a of the sonotrodes 37 may be individualized for specific weld positions.

As illustrated in FIG. 6, in order to ensure the flexibility of position and weld type in the individual welding station 20′ a container or rack 38 can be provided, which is positioned in a predetermined way and from which the welding machine 30 with a tooling quick change fitting 39 may rapidly change the welding head 35 in the intervals between different welds of the panels. Alternatively or additionally, a container or rack can be provided for automated change of the sole sonotrodes (not shown).

In order to maintain stability of components 10, 10′ of panel 1 during welding pneumatically or hydraulically adjustable pistons indicated by 35a in FIG. 7 are preferably fitted to the welding heads 35 for exerting a vertical thrust on the components 10, 10′ during welding. In order to ensure a sufficient pressure of the welding tools 37 on uneven or variable surfaces, a constant compression spring indicated by 35b in FIG. 8 is preferably fitted to the welding heads 35. Alternatively another type of device can be provided for ensuring constant pressure of the sonotrode on the components irrespective of their wall thickness.

Assembly line control and panel sequence management are via a computerized controller 40. The ultrasonic welding generators and wave control are as well contained in the controller 40, which also manages movement of the welding machines 34. Due to the spatial flexibility of the robotic welders the controller 40 permits simple and rapid reprogramming of the weld point positions for each individual door panel in the case of design modification. In particular, each welding head may be individually programmed for specific welds. A high level of welding optimization can thereby be obtained.

As can be appreciated, the method and apparatus of the present invention provides for efficient, flexible and optimal assembly and welding in any assembly sequence of automotive door panels and their components.

Obviously, without prejudice to the principle of the invention the realization details and embodiments may be widely modified with respect to what described and shown without departing from the scope of the invention.

1. A method for assembling and welding vehicle door panels, comprising the following steps:
at an initial assembly station components of said panels are assembled and arranged on a plurality of plates or carriages for carrying said panels, which are profiled in a way adaptable to the shape of the panels,
said plates or carriages with the components of the panels are automatedly transported to a station for welding the components,
at said welding station at least one welding head, which is movable with a plurality of degrees of freedom, is automatedly positioned and orientated, and if necessary, the configuration of said welding head is automatedly changed, according to a welding sequence which depends from the design specifications of the panels,
said plates or carriages with the assembled and welded panels are automatedly transported to a removal station,
at said removal station, the assembled and welded panels are removed, and
the unloaded plates or carriages are automatedly returned from said removal station to said initial station,
wherein those of said steps which are automatedly performed are coordinated in adaptable and programmable fashion according to a processing sequence which depends from the design specifications of said panels.

2. A method according to claim 1, wherein said step of automatedly returning the unloaded plates or carriages is performed by arranging said plates or carriages in a randomly generated sequence.

3. An apparatus for assembling and welding vehicle door panels, comprising:
a plurality of work stations, comprising an initial station for assembling components of said panels, at least one station for welding said components which comprises at least one welding head movable with a plurality of degrees of freedom, and at least one reconfigurable welding head, changing means being provided for automatedly changing the configuration of said reconfigurable welding head, and at least one station for removing the assembled and welded panels,
transfer means for transporting said panels from a first work station to another work station, said transfer means being provided with a plurality of plates or carriages for carrying said panels which are profiled in a way adaptable to the shape of said panels, and comprising return means for returning the unloaded plates or carriages from said removal station to said initial station, and
control means which are programmed for adaptably coordinating said transfer means, welding heads and changing means according to a processing sequence which depends from the design specifications of said panels.

4. An apparatus according to claim 3, wherein said work stations are modular and interchangeable.

5. An apparatus according to claim 3, wherein said transfer means comprise a conveyor line, and said plates or carriages comprise a base part which is movable on said conveyor line, and an interchangeable part which is releasably fixed to said base part and is profiled for supporting a predetermined type of panel.

6. An apparatus according to claim 5, wherein said return means comprise a plurality of return lines which are vertically positioned with respect to the conveyor line, and first and second lift systems which are disposed at respective opposite ends of the transport line.

7. An apparatus according to, claim 3, wherein said control means are programmed for operating said return means in such a way to arrange said plates or carriages in a randomly generated sequence and for operating in a corresponding way said conveyor line, welding heads and changing means.

8. An apparatus according to claim 3, wherein said at least one welding head is provided with means for maintaining stability of the components of the panels during welding.

9. An apparatus according to claim 8, wherein said stability maintaining means comprise pneumatically or hydraulically adjustable pistons.

10. An apparatus according to claim 3, wherein said at least one welding head is provided with means for pressing the welding head against said panels.

11. An apparatus according to claim 10, wherein said pressing means comprise a constant compression elastic device.
